(19) United States
(12) Patent Application Publication
(10) Pub. No.: US 2005/0123241 A1
(43) Pub. Date: Jun. 9, 2005

(54) Polarization independent frequency selective optical coupler

(76) Inventors: Moti Margalit, Zichron Yaakov (IL); Dafna Bortman Arbiv, Zichron (IL); Gideon Rogovsky, Tel Aviv (IL)

Correspondence Address: Lambda Crossing, Ltd.;c/o Landon IP, Inc., Suite 450, 1700 Diagonal Road, Alexandria, VA, 22314, US

(21) Appl. No.: 10/980,768

(22) Filed: Nov. 4, 2004

Related U.S. Application Data
(60) Provisional application No. 60/526,277, filed on Dec. 3, 2003.
(60) Provisional application No. 60/543,262, filed on Feb. 11, 2004.

(51) Int. Cl. G02B 6/26

(52) U.S. Cl. 385/39

(57) ABSTRACT

A polarization independent, frequency selective coupler for coupling an optical signal having at least one wavelength and an arbitrary polarization state, the polarization independent, frequency selective optical coupler comprising: a first waveguide; and at least one second waveguide, a first portion of the at least one second waveguide being in close proximity to the first waveguide thus forming at least one evanescent coupling region, the at least one evanescent coupling region exhibiting a first phase match condition coupling the TM mode of an optical signal propagating in the first waveguide to the at least one second waveguide and a second phase match condition coupling the TE mode of the optical signal propagating in the first waveguide to the at least one second waveguide, the first phase match condition being different than the second phase match condition.

### CROSS-REFERENCE TO RELATED APPLICATIONS

This application claims priority from U.S. Provisional Patent Application Ser. No. 60/526,277 filed Dec. 3, 2003 entitled “Integrated Bi-directional Transceiver Planar Lightwave Circuit”; and U.S. Provisional Patent Application Ser. No. 60/543,262 filed Feb. 11, 2004 entitled “Polarization Independent Frequency Selective Optical Coupler”; the entire contents of both of which are incorporated herein by reference.

### BACKGROUND OF THE INVENTION

The invention relates generally to the field of planar lightwave circuits and in particular to a polarization independent frequency selective optical coupler.

In recent years fiber to the home (FTTH) has become popular as a means for supplying broadband communications services to the home user. To implement this technology at minimum cost, a single optical fiber is utilized bi-directionally by providing for optical transmission at a different wavelength in each direction. Typically, transmission downstream, which is from the central office to the home, is accomplished at a wavelength of approximately 1.5 μm, and transmission upstream, which is from the home to the central office, is accomplished at a wavelength of approximately 1.3 μm. In an exemplary embodiment, downstream transmission is accomplished at multiple wavelengths in the vicinity of 1.5 μm. Selection of the wavelengths used for the downstream and upstream transmission is primarily a function of the economics of the transmission sources, with transmitting lasers at 1.5 μm being more expensive than transmitting lasers at 1.3 μm, and the need to multiplex and subsequently demultiplex the combined signals at a low cost.

Implementation of such an FTTH scheme requires the installation of a bi-directional optical transceiver at each customer premises, thus reducing the cost of such a bi-directional optical transceiver is a major factor in the cost of implementation of FTTH solutions.

Prior art bi-directional optical transceivers are typically comprised of multiple discrete elements including: a transmitter such as a laser diode; a detector such as a photo-detector; and an optical filter. In the event of multiple downstream wavelengths, multiple detectors are typically required. Each of these components, typically packaged in a transistor outline metal can, is assembled into a bi-directional optical transceiver. Assembly of such a device is costly, in particular in light of the added difficulty and cost of alignment of multiple optical parts. Thus it is desirable to reduce the cost of a bi-directional optical transceiver by utilizing planar lightwave circuits.

Planar lightwave circuits are typically formed on a substrate. Various types of waveguides having differing refractive index are known to the prior art. For the purposes of this document, the refractive index of a waveguide will be defined at a wavelength of 1.5 μm. Silicon dioxide (SiO₂) is often used as a cladding material and exhibits a refractive index of 1.4445. A waveguide material known to the prior art is SiON, which can be deposited in a range of refractive indexes, typically from 1.48-1.55. SiON is hereinafter termed a low index waveguide material. A high index waveguide material known to the prior art is Si₃N₄, which can be deposited in a range of refractive indexes, typically from 2.0-2.2. Other high index waveguide materials are known to those skilled in the art. For the purposes of this document, waveguides whose refractive indexes are in excess of 1.6 are hereinafter called high index waveguides.

Planar waveguides exhibit both a height and a width. In order for a waveguide to be polarization independent, that is to exhibit the same effective refractive index for both the TE and TM modes, it is necessary for the height and width of the planar waveguide to be nearly identical. Practically, this is not currently economically achievable, in particular for Si₃N₄ waveguides that are commercially restricted to a width range of 1-2 μm and a height range of 0.05-0.3 μm. It is difficult to produce a waveguide exhibiting a width of less than 0.5 μm.

One design consideration for planar waveguide circuits is whether the planar waveguide will be single mode or multimode over the desired waveband. It is to be noted that as the refractive index of the waveguide core material increases the planar waveguide supports multiple modes, i.e. modes in addition to the fundamental TM and TE modes, for a decreasing height and width. Thus, modifying the waveguide height and width may change the waveguide from single mode to multi-mode. It is to be understood that the term single mode operation includes both the TM and TE modes. The single mode having both a TM and TE mode is sometimes referred to as the fundamental mode. In multiple mode operation, or multi-mode as it is sometimes referred to, both a TM and TE mode exist for both the fundament mode and for each present high order mode.

A further design consideration for planar waveguide circuits is the effective refractive index, indicated hereinafter as N_{eff}, of the planar waveguide for a given mode. For a core material with a given refractive index, the larger the dimensions in terms of height or width, the larger the effective refractive index, until the effective refractive index approaches the material refractive index. It is to be noted however, that as indicated above for commercially producible planar waveguides, and in particular high index waveguides, the N_{eff} of the TM and TE modes differ.

The N_{eff} of a planar waveguide is a function of wavelength, denoted λ, with a shorter wavelength experiencing a larger N_{eff} and a longer wavelength experiencing a smaller N_{eff}. For a waveguide in which the N_{eff} is significantly less than the material refractive index due to the dimensions of the waveguide, changing the height or width of the waveguide affects the slope of the relationship between N_{eff} and λ. In particular, for a waveguide core having a given refractive index and width in which N_{eff} is a function of λ, increasing the height will increase the slope.

Planar waveguide circuits known to the prior art include couplers formed by placing two waveguides in close vicinity of one another so that their respective mode profiles overlap each other to form an evanescent coupler region. The transfer of energy is determined by the coupled mode wave equations and is a function of N_{eff} of each of the waveguides, as described in detail in “Optical Electronics in Modern Communications”, Oxford University Press (1977), 5^{th} edition, at page 522, section 13.8 whose contents are incorporated by reference. Effective coupling is achieved when the effective indexes of the two waveguides match.

An article entitled “Integrated Optic Adiabatic Devices on Silicon” by Y. Shani et al. published in the IEEE Journal of Quantum Electronics, Vol. 27, No. 3, Page 556-566, March 1991, whose contents are incorporated herein by reference, describes an asymmetric y-coupler for polarization splitting; an adiabatic full coupler; an adiabatic 3 db coupler and an asymmetric y-coupler for a 1.3-1.55 μm multiplexer. The asymmetric y-coupler is not polarization independent. The article further describes a polarization splitter using a birefringent high index waveguide, and an improved performance splitter utilizing double filtering. A wavelength division multiplexer based on an adiabatic Y-branch is further described. Unfortunately, such a wavelength division multiplexer is not polarization independent.

It is understood by those skilled in the art that a wavelength division multiplexer is a specific example of a frequency selective optical coupler.

Grating-assisted couplers are known to the art and described for example in an article entitled “Grating-Assisted Codirectional Coupler Filter Using Electrooptic and Passive Polymer Waveguides” by S. Ahn et al. published in the IEEE Journal on Selected Topics in Quantum Electronics, Vol. 7, No. 5, September/October 2001, Pages 819-825 whose contents are incorporated herein by reference.

Thus there is a need for an improved PLC based polarization independent frequency selective optical coupler.

### SUMMARY OF THE INVENTION

Accordingly, it is a principal object of the present invention to overcome the disadvantages of prior art PLC based polarization independent frequency selective optical couplers. This is provided in the present invention by a polarization independent, frequency selective optical coupler for coupling an optical signal having at least one wavelength and an arbitrary polarization state, the polarization independent, frequency selective optical coupler comprising: a first waveguide; and at least one additional waveguide in close proximity to the first waveguide thus forming at least one evanescent coupling region; the at least one evanescent coupling region exhibiting a first phase match condition coupling the TM mode of the optical signal and a second phase match condition coupling the TE mode of the optical signal, the first phase match condition being different than the second phase match condition. The phase match conditions are in one embodiment a function of the size of the waveguides, and in another embodiment a function of at least one grating written thereon.

The invention provides for a polarization independent, frequency selective coupler for coupling an optical signal having at least one wavelength and an arbitrary polarization state, the polarization independent, frequency selective optical coupler comprising: a first waveguide; and at least one second waveguide, a first portion of the at least one second waveguide being in close proximity to the first waveguide thus forming at least one evanescent coupling region, the at least one evanescent coupling region exhibiting a first phase match condition coupling the TM mode of an optical signal propagating in the first waveguide to the at least one second waveguide and a second phase match condition coupling the TE mode of the optical signal propagating in the first waveguide to the at least one second waveguide, the first phase match condition being different than the second phase match condition.

In one embodiment the polarization independent frequency selective coupler further comprises a first grating written on a first portion of the at least one second waveguide within the at least one evanescent coupling region, the first grating being associated with the first phase match condition, and a second grating written on a second portion of the at least one second waveguide within the at least one evanescent coupling region, the second grating being associated with the second phase match condition. In a further embodiment the first grating exhibits a first period and the second grating exhibits a second period, the first period being different than the second period. In one yet further embodiment the first and second gratings at least partially overlap. In another yet further embodiment the first portion is substantially identical with the second portion, the first grating being superimposed over the second grating.

In one embodiment the at least one second waveguide forming the at least one evanescent coupling region comprises a first sub-portion having a first characteristic height and width being associated with the first phase match condition and a second sub-portion having a second characteristic height and width being associated with the second phase match condition. In a further embodiment the polarization independent frequency selective coupler further comprises a grating written on at least a portion of one of the first sub-portion and the second sub-portion. In a yet further embodiment the grating exhibits a uniform period over the at least a portion of one of the first sub-portion and the second sub-portion, and optionally the first waveguide comprises core material exhibiting a refractive index between 1.48 and 1.55 at 1.5 μm and the at least one second waveguide comprises core material exhibiting a refractive index in excess of 1.6 at 1.5 μm.

In one embodiment the at least one second waveguide forming the at least one evanescent coupling region comprises a first sub-portion having a first characteristic height and width being associated with the first phase match condition and a second sub-portion having a second characteristic height and width being associated with the second phase match condition, and optionally a) wherein the first waveguide comprises core material exhibiting a refractive index between 1.48 and 1.55 at 1.5 μm and the at least one second waveguide comprises core material exhibiting a refractive index in excess of 1.6 at 1.5 μm or b) wherein the first waveguide comprises core material exhibiting a refractive index in excess of 1.6 at 1.5 μm and the at least one second waveguide comprises core material exhibiting a refractive index between 1.48 and 1.55 at 1.5 μm.

In one embodiment wherein the optical signal comprises at least one wavelength, the at least one second waveguide supports at least one high order mode at the at least one wavelength. In one further embodiment at least one of the first phase match condition coupling the TM mode and the second phase match condition coupling the TE mode is associated with the at least one high order mode. In another further embodiment the at least one second waveguide forming the at least one evanescent coupling region comprises a first sub-portion having a first characteristic height and width being associated with the first phase match condition and a second sub-portion having a second characteristic height and width being associated with the second phase match condition. Optionally, at least one of the first phase match condition coupling the TM mode and the second phase match condition coupling the TE mode is associated with the first sub-portion and is further associated with the at least one high order mode.

In one embodiment the optical signal comprises at least one wavelength; the at least one second waveguide forming the at least one evanescent coupling region supports, at the at least one wavelength, at least two modes, at least one of the at least two modes being a high order mode; the at least one second waveguide comprising: a first sub-portion having a first characteristic height and width being associated with the first phase match condition coupling the TM mode and being further associated with a first one of the at least two modes; and a second sub-portion having a second characteristic height and width being associated with the second phase match condition coupling the TE mode and being further associated with a second one of the at least two modes; the second one of the at least two modes being different than the first one of the at least two modes.

In one embodiment the first waveguide comprises core material exhibiting a refractive index between 1.48 and 1.55 at 1.5 μm. In another embodiment the at least one second waveguide comprises core material exhibiting a refractive index in excess of 1.6 at 1.5 μm. In yet another embodiment the at least one second waveguide comprises core material exhibiting a refractive index between 2.0 and 2.2 at 1.5 μm. In yet another embodiment the first waveguide comprises core material exhibiting a refractive index between 1.48 and 1.55 at 1.5 μm and the at least one second waveguide comprises core material exhibiting a refractive index between 2.0 and 2.2 at 1.5 μm.

In one embodiment the first waveguide comprises core material exhibiting a refractive index between 2.0 and 2.2 at 1.5 μm and the at least one second waveguide comprises core material exhibiting a refractive index between 2.0 and 2.2 at 1.5 μm. In a further embodiment the height of the first waveguide is between 0.15 and 0.3 microns and the width of the first waveguide is between 0.8 and 1.3 microns. In a yet further embodiment the height of the at least one second waveguide is between 0.15 and 0.3 microns and the width of the at least one second waveguide is between 2 and 7 microns.

In one embodiment the at least one second waveguide comprises two waveguides. In a further embodiment a first one of the two waveguides is associated with the TM mode. In a yet further embodiment a second one of the two waveguides is associated with the TE mode. In another further embodiment a first one of the two waveguides is associated with the TM mode, and a second one of the two waveguides is associated with the TE mode. In a yet further embodiment the polarization independent frequency selective coupler further comprises an output waveguide, the output waveguide being in close proximity to a second portion of the first one of the two waveguides forming an evanescent coupling region, the output waveguide further being in close proximity to a second portion of the second one of the two waveguides forming an evanescent coupling region. Optionally, the length of the first one of the second two waveguides and the second one of the second two waveguides is selected so that the propagation time of the TM mode and the TE mode of the optical signal from the input of the first waveguide to the output of the output waveguide are substantially equivalent.

The invention also provides for a method of polarization independent frequency selective coupling for an optical signal having at least one wavelength and an arbitrary polarization state, the polarization independent frequency selective optical coupling comprising: coupling by a first phase match condition the TM mode of the optical signal in at least one evanescent coupling region; and coupling by a second phase match condition the TE mode of the optical signal in the at least one evanescent coupling region, the first phase match condition being different from the second phase match condition.

The invention also provides for a polarization independent, frequency selective coupler for coupling an optical signal having at least one wavelength and an arbitrary polarization state, the polarization independent, frequency selective optical coupler comprising: a first waveguide; and a second waveguide, a first portion of the second waveguide being in close proximity to the first waveguide thus forming an evanescent coupling region, the evanescent coupling region exhibiting a first phase match condition coupling the TM mode of an optical signal propagating in the first waveguide to the second waveguide and a second phase match condition coupling the TE mode of the optical signal propagating in the first waveguide to the second waveguide, the first phase match condition being different than the second phase match condition.

In one embodiment at least one of the first and second phase match conditions are a function of one of a grating, a high order mode and a characteristic height and width.

The invention also provides for a polarization independent, frequency selective coupler for coupling an optical signal having at least one wavelength and an arbitrary polarization state, the polarization independent, frequency selective optical coupler comprising: a first waveguide acting as an input waveguide; a second waveguide; a third waveguide; and a fourth waveguide acting as an output waveguide; a first portion of the second waveguide being in close proximity to the first waveguide thus forming an evanescent coupling region exhibiting a first phase match condition coupling the TM mode of an optical signal propagating in the first waveguide to the second waveguide, a second portion of the second waveguide being in close proximity to the fourth waveguide thus forming an evanescent coupling region; a first portion of the third waveguide being in close proximity to the first waveguide thus forming an evanescent coupling region exhibiting a second phase match condition coupling the TE mode of the optical signal propagating in the first waveguide to the third waveguide, a second portion of the second waveguide being in close proximity to the fourth waveguide thus forming an evanescent coupling region, the first phase match condition being different than the second phase match condition.

In one embodiment the lengths of the second waveguide and the third waveguides are selected so that the propagation time of the TM mode and the TE mode of the optical signal from the input of the first waveguide to the output of the fourth waveguide are substantially equivalent.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1a illustrates an embodiment of a bi-directional optical transceiver planar lightwave circuit (PLC) structure having a single downstream wavelength in accordance with the principle of the present invention;

FIG. 1b illustrates another embodiment of a bi-directional optical transceiver planar lightwave circuit (PLC) structure having a single downstream wavelength in accordance with the principle of the present invention;

FIG. 2a illustrates a first embodiment of a bi-directional optical transceiver PLC structure having multiple downstream wavelengths in accordance with the principles of the current invention;

FIG. 2b illustrates a second embodiment of a bi-directional optical transceiver PLC structure having multiple downstream wavelengths in accordance with the principles of the current invention;

FIG. 2c illustrates a third embodiment of a bi-directional optical transceiver PLC structure having multiple downstream wavelengths in accordance with the principles of the current invention;

FIG. 2d illustrates a fourth embodiment of a bi-directional optical transceiver PLC structure having multiple downstream wavelengths in accordance with the principles of the current invention;

FIG. 2e illustrates a fifth embodiment of a bi-directional optical transceiver PLC structure having multiple downstream wavelengths in accordance with the principles of the current invention;

FIG. 3a illustrates a high level schematic diagram of an embodiment of the frequency selective optical coupler of FIGS. 1a-1b and 2a-2c in accordance with the principle of the current invention;

FIG. 3b illustrates a high level schematic diagram of an embodiment of the polarization independent frequency selective optical coupler of FIGS. 2a, 2b in accordance with the principle of the current invention;

FIG. 3c illustrates a high level schematic diagram of an embodiment of the polarization independent frequency selective dual optical coupler of FIGS. 2c-2e in accordance with the principle of the current invention;

FIG. 4a illustrates a high level schematic diagram of a first embodiment of an evanescent coupling region of the polarization independent frequency selective optical coupler of FIGS. 2a, 2b and 3b and of the polarization independent frequency selective dual optical coupler of FIG. 2c-2e and 3c in accordance with the principle of the current invention;

FIG. 4b illustrates a high level schematic diagram of a second embodiment of an evanescent coupling region of the polarization independent frequency selective optical coupler of FIGS. 2a, 2b and 3b and of the polarization independent frequency selective dual optical coupler of FIG. 2c-2e and 3c in accordance with the principle of the current invention;

FIG. 4c illustrates a high level schematic diagram of a third embodiment of an evanescent coupling region of the polarization independent frequency selective optical coupler of FIGS. 2a, 2b and 3b and of the polarization independent frequency selective dual optical coupler of FIG. 2c-2e and 3c in accordance with the principle of the current invention;

FIG. 4d illustrates a high level schematic diagram of a fourth embodiment of an evanescent coupling region of the polarization independent frequency selective optical coupler of FIGS. 2a, 2b and 3b and of the polarization independent frequency selective dual optical coupler of FIG. 2c-2e and 3c in accordance with the principle of the current invention;

FIG. 4e illustrates a high level schematic diagram of a fifth embodiment of an evanescent coupling region of the polarization independent frequency selective optical coupler of FIGS. 2a, 2b and 3b and of the polarization independent frequency selective dual optical coupler of FIG. 2c-2e and 3c in accordance with the principle of the current invention;

FIG. 4f illustrates a high level schematic diagram of a sixth embodiment of an evanescent coupling region of the polarization independent frequency selective optical coupler of FIGS. 2a, 2b and 3b and of the polarization independent frequency selective dual optical coupler of FIG. 2c-2e and 3c in accordance with the principle of the current invention; and

FIG. 4g illustrates a high level schematic diagram of a seventh embodiment of an evanescent coupling region of the polarization independent frequency selective optical coupler of FIGS. 2a, 2b and 3b and of the polarization independent frequency selective dual optical coupler of FIG. 2c-2e and 3c in accordance with the principle of the current invention.

### DETAILED DESCRIPTION OF THE PREFERRED EMBODIMENTS

The present embodiments enable a PLC based polarization independent frequency selective optical coupler. In one embodiment the PLC based polarization independent frequency selective optical coupler comprises a first waveguide and a second waveguide forming an evanescent coupling region, the first and second waveguides exhibiting a plurality of unique coupling conditions. One coupling condition is operable on the TM mode, and a separate different coupling condition is operable on the TE mode. In another embodiment the PLC based polarization independent frequency selective optical coupler comprises a first waveguide and a second set of waveguides, each waveguide of the second set of waveguides forming an evanescent coupling region with the first waveguide, and each of the coupling waveguides being associated with one of the TM and TE modes.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

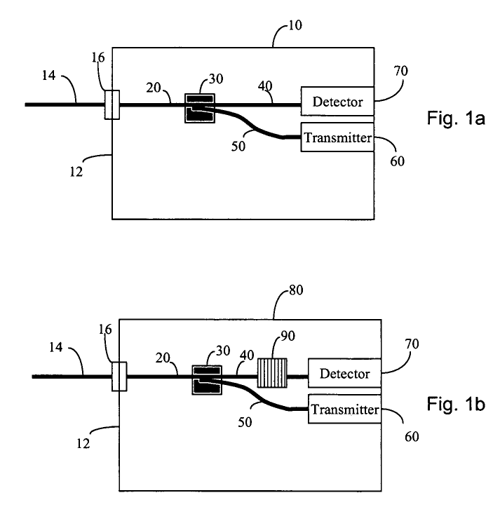

FIG. 1a illustrates an embodiment of a bi-directional optical transceiver planar lightwave circuit (PLC) structure in accordance with the principle of the invention, generally denoted 10, comprising: substrate 12; input/output optical fiber 14; fiber attachment 16; planar waveguide 20; frequency selective optical coupler 30; planar waveguide 40; high index planar waveguide 50; transmitter 60, which in a preferred embodiment comprises a laser diode; and detector 70, which in a preferred embodiment comprises a photo-detector. Input/output optical fiber 14 is connected at fiber attachment 16 to a first end of planar waveguide 20, and a second end of planar waveguide 20 is connected to a first port of frequency selective optical coupler 30. One end of high index planar waveguide 50 is connected to a second port of frequency selective optical coupler 30 and a second end of high index planar waveguide 50 is connected to transmitter 60. One end of planar waveguide 40 is connected to a third port of frequency selective optical coupler 30, and a second end of planar waveguide 40 is connected to detector 70.

In operation, an incoming optical signal propagating through input/output optical fiber 14 is connected through fiber attachment 16 to planar waveguide 20. Fiber attachment 16 is preferably an embedded pigtail assembly. The incoming optical signal represents downstream transmission at a first wavelength, typically on the order of 1.5 μm, and propagates through planar waveguide 20 to frequency selective optical coupler 30. The incoming optical signal propagates through frequency selective optical coupler 30 to planar waveguide 40 and ultimately to detector 70. Transmitter 60 is operable to transmit an upstream optical signal at a second wavelength, typically on the order of 1.3 μm, the second wavelength being distinct and separated from the first wavelength. The upstream optical signal output from transmitter 60 propagates through high index planar waveguide 50 to frequency selective optical coupler 30, and is coupled through frequency selective optical coupler 30 to planar waveguide 20. It is to be noted that transmitter 60, which typically comprises a laser diode, operates with a specific polarity. Thus, in an exemplary embodiment, frequency selective optical coupler 30 is a polarization dependent coupler that is selected to couple optical signals having the polarization output by transmitter 60 to planar waveguide 20. Generally, frequency selective optical coupler 30 couples the downstream wavelength to planar waveguide 40, and the upstream wavelength from high index planar waveguide 50 to planar waveguide 20. The upstream optical signal propagates through first planar waveguide 20 through connector 16, and propagates through input/output optical fiber 14. Thus device 10 of FIG. 1a is thus operable to supply bi-directional optical transmission at two distinct wavelengths.

FIG. 1b illustrates another embodiment of a bi-directional optical transceiver PLC structure in accordance with the principle of the invention, generally denoted 80, comprising: substrate 12; input/output optical fiber 14; fiber attachment 16; planar waveguide 20; frequency selective optical coupler 30; planar waveguide 40; extinction enhancement grating 90; high index planar waveguide 50; transmitter 60, which in a preferred embodiment comprises a laser diode; and detector 70, which in a preferred embodiment comprises a photo-detector. Input/output optical fiber 14 is connected at fiber attachment 16 to a first end of planar waveguide 20, and a second end of planar waveguide 20 is connected to a first port of frequency selective optical coupler 30. One end of high index planar waveguide 50 is connected to a second port of frequency selective optical coupler 30 and a second end of high index planar waveguide 50 is connected to transmitter 60. One end of planar waveguide 40 is connected to a third port of frequency selective optical coupler 30, and a second end of planar waveguide 40 is connected to detector 70. Extinction enhancement grating 90 is written on planar waveguide 40 between frequency selective optical coupler 30 and detector 70.

In operation bi-directional optical transceiver PLC structure 80 operates in a manner similar to that described above in relation to bi-direction optical transceiver PLC structure 10 of FIG. 1a, with an improved signal to noise (S/N) ratio as a result of the operation of extinction enhancement grating 90. Extinction enhancement grating 90 is preferably selected to be a notch filter suppressing all but the designated downstream wavelength and passing only the designated downstream wavelength to detector 70.

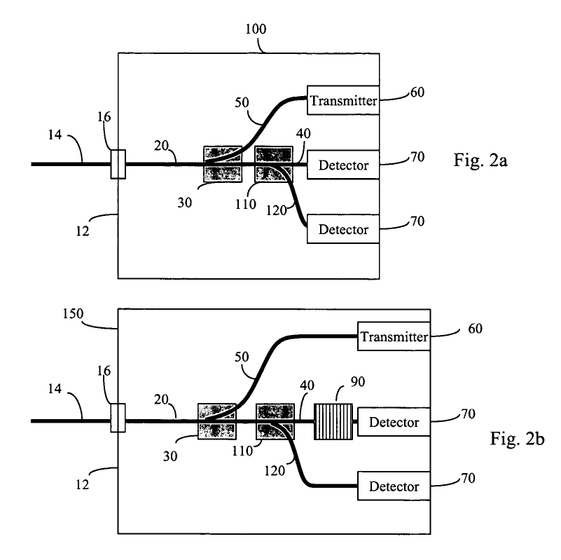

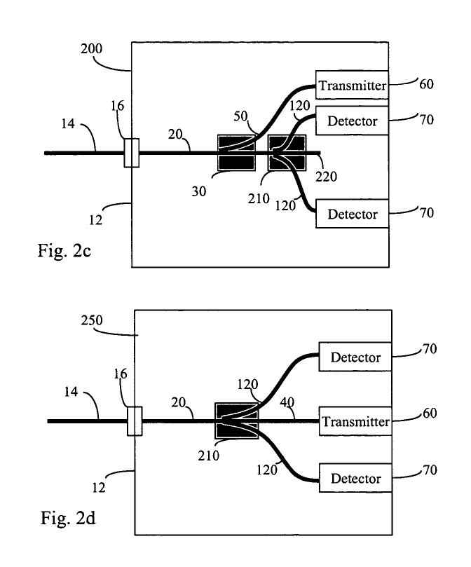

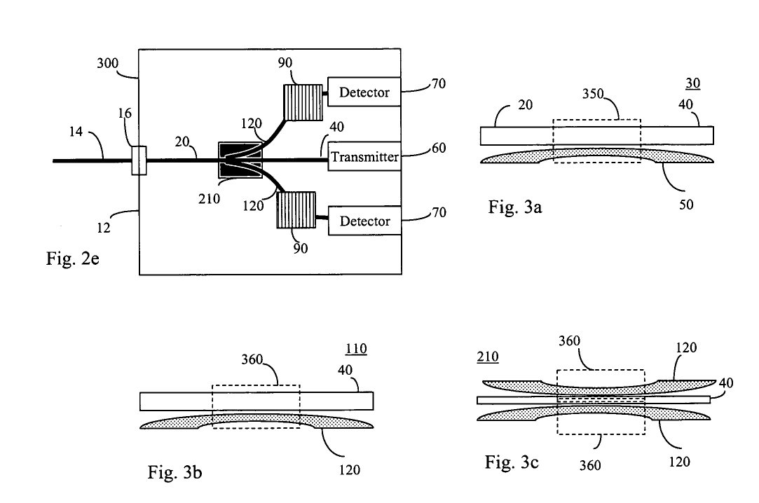

FIG. 2a illustrates a first embodiment of a bi-directional optical transceiver PLC structure in accordance with the principle of the invention, generally denoted 100, supporting two downstream wavelengths. PLC structure 100 comprises: substrate 12; input/output optical fiber 14; fiber attachment 16; planar waveguide 20; frequency selective optical coupler 30; planar waveguide 40; high index planar waveguide 50; transmitter 60, which in a preferred embodiment comprises a laser diode; first and second detectors 70, which in a preferred embodiment each comprise a photo-detector; polarization independent frequency selective optical coupler 110; and high index planar waveguide 120. Input/output optical fiber 14 is connected at fiber attachment 16 to a first end of planar waveguide 20, and a second end of planar waveguide 20 is connected to a first port of frequency selective optical coupler 30. One end of high index planar waveguide 50 is connected to a second port of frequency selective optical coupler 30 and a second end of high index planar waveguide 50 is connected to transmitter 60. A second port of frequency selective optical coupler 30 is connected to a first port of polarization independent frequency selective optical coupler 110, preferably through a planar waveguide. One end of high index planar waveguide 120 is connected to a second port of polarization independent frequency selective optical coupler 110, and a second end high index planar waveguide 120 is connected to first detector 70. One end of planar waveguide 40 is connected to a third port of polarization independent frequency selective optical coupler 110, and a second end of planar waveguide 40 is connected to second detector 70.

In operation, an incoming optical signal propagating through input/output optical fiber 14 is connected through fiber attachment 16 to planar waveguide 20. Fiber attachment 16 is preferably an embedded pigtail assembly. The incoming optical signal comprises downstream transmission at a first and second wavelength, with a first wavelength being typically on the order of 1.5 μm, and a second wavelength being typically on the order of 1.49 μm. The incoming optical signal, comprising first and second wavelengths, propagates through planar waveguide 20 to frequency selective optical coupler 30 and propagates through frequency selective optical coupler 30 to polarization independent frequency selective optical coupler 110. Polarization independent frequency selective optical coupler 110 is operable to couple out a first downstream wavelength to high index planar waveguide 120, and the first downstream wavelength thus propagates through high index planar waveguide 120 to detector 70. The second downstream wavelength passes through polarization independent frequency dependent optical coupler 110 to planar waveguide 40 and ultimately to second detector 70. Transmitter 60 is operable to transmit an upstream optical signal at a third wavelength, typically on the order of 1.3 μm, the third wavelength being distinct and separated from the first and second wavelengths. The upstream optical signal output from transmitter 60 propagates through high index planar waveguide 50 to frequency selective optical coupler 30, and is coupled through frequency selective optical coupler 30 to planar waveguide 20. It is to be noted that transmitter 60, which typically comprises a laser diode, operates with a specific polarity. Thus, in an exemplary embodiment, frequency selective optical coupler 30 is a polarization dependent coupler that is selected to couple optical signals having the polarization output by transmitter 60 to planar waveguide 20. Generally, frequency selective optical coupler 30 couples first and second downstream wavelengths to polarization independent frequency selective optical coupler 110, and the upstream wavelength from high index planar waveguide 50 to planar waveguide 20 The upstream optical signal propagates through first planar waveguide 20 through connector 16, and propagates through input/output optical fiber 14.

It is to be noted that the architecture of bi-directional optical transceiver PLC structure 100 is distinctive in having upstream frequency selective optical coupler 30 closer to input/output optical fiber 14 than polarization independent frequency selective optical coupler 110, and thus the output of transmitter 60 does not propagate through polarization independent frequency selective optical coupler 110. Thus device 100 of FIG. 2a is operable to supply bi-directional optical transmission at two distinct downstream wavelengths and a separate distinct upstream wavelength.

FIG. 2b illustrates a second embodiment of a bi-directional optical transceiver PLC structure in accordance with the principle of the invention, generally denoted 150, supporting two downstream wavelengths. PLC structure 150 comprises: substrate 12; input/output optical fiber 14; fiber attachment 16; planar waveguide 20; frequency selective optical coupler 30; planar waveguide 40 having extinction enhancement grating 90 written on a portion thereof; high index planar waveguide 50; transmitter 60, which in a preferred embodiment comprises a laser diode; first and second detectors 70, which in a preferred embodiment each comprise a photo-detector; polarization independent frequency selective optical coupler 110; and high index planar waveguide 120. Input/output optical fiber 14 is connected at fiber attachment 16 to a first end of planar waveguide 20, and a second end of planar waveguide 20 is connected to a first port of frequency selective optical coupler 30. One end of high index planar waveguide 50 is connected to a second port of frequency selective optical coupler 30 and a second end of high index planar waveguide 50 is connected to transmitter 60. A second port of frequency selective optical coupler 30 is connected to a first port of polarization independent frequency selective optical coupler 110, preferably through a planar waveguide. One end of high index planar waveguide 120 is connected to a second port of polarization independent frequency selective optical coupler 110, and a second end high index planar waveguide 120 is connected to first detector 70. One end of planar waveguide 40 is connected to a third port of polarization independent frequency selective optical coupler 110, and a second end of planar waveguide 40 is connected to second detector 70. Extinction enhancement grating 90 is written on a portion of planar waveguide 40 between second detector 70 and polarization independent frequency selective optical coupler 110.

In operation bi-directional optical transceiver PLC structure 150 operates in a manner similar to that described above in relation to bi-direction optical transceiver PLC structure 100 of FIG. 2a, with an improved S/N ratio as a result of the operation of extinction enhancement grating 90. Extinction enhancement grating 90 is preferably selected to be a notch filter suppressing all but the designated downstream wavelength destined for second detector 70 and passing only the designated downstream wavelength to second detector 70.

FIG. 2c illustrates a third embodiment of a bi-directional optical transceiver PLC structure in accordance with the principle of the invention, generally denoted 200, supporting two downstream wavelengths. PLC structure 200 comprises: substrate 12; input/output optical fiber 14; fiber attachment 16; planar waveguide 20; frequency selective optical coupler 30; high index planar waveguide 50; transmitter 60, which in a preferred embodiment comprises a laser diode; first and second detectors 70, which in a preferred embodiment each comprise a photo-detector; polarization independent frequency selective dual optical coupler 210; and first and second high index planar waveguides 120. Input/output optical fiber 14 is connected at fiber attachment 16 to a first end of planar waveguide 20, and a second end of planar waveguide 20 is connected to a first port of frequency selective optical coupler 30. One end of high index planar waveguide 50 is connected to a second port of frequency selective optical coupler 30 and a second end of high index planar waveguide 50 is connected to transmitter 60. A second port of frequency selective optical coupler 30 is connected to a first port of polarization independent frequency selective dual optical coupler 210, preferably through a planar waveguide. One end of first high index planar waveguide 120 is connected to a second port of polarization independent frequency selective dual optical coupler 210, and a second end of first high index planar waveguide 120 is connected to first detector 70. One end of second high index planar waveguide 120 is connected to a third port of polarization independent frequency selective dual optical coupler 210, and a second end of second high index planar waveguide 120 is connected to second detector 70. A fourth port of frequency selective dual optical coupler 220, the through port, is unused.

In operation, an incoming optical signal propagating through input/output optical fiber 14 is connected through fiber attachment 16 to planar waveguide 20. Fiber attachment 16 is preferably an embedded pigtail assembly. The incoming optical signal comprises downstream transmission at a first and second wavelength, with a first wavelength being typically on the order of 1.5 μm, and a second wavelength being typically on the order of 1.49 μm. The downstream optical signal, comprising first and second wavelengths, propagates through planar waveguide 20 to frequency selective optical coupler 30 and through frequency selective optical coupler 30 to polarization independent frequency selective dual optical coupler 210. Polarization independent frequency selective dual optical coupler 210 is operable to couple out a first downstream wavelength to first high index planar waveguide 120, and a second downstream wavelength to second high index planar waveguide 120. The first downstream wavelength thus propagates through first high index planar waveguide 120 to first detector 70 and the second downstream wavelength thus propagates through second high index planar waveguide 120 to second detector 70. Any remaining downstream optical signal not coupled to first and second high index planar waveguide 120 is dissipated in unconnected fourth port 220.

Transmitter 60 is operable to transmit upstream signals at a third wavelength, typically on the order of 1.3 μm, the third wavelength being distinct and separated from the first and second wavelengths. The upstream optical signal output from transmitter 60 propagates through high index planar waveguide 50 to frequency selective optical coupler 30, and is coupled through frequency selective optical coupler 30 to planar waveguide 20. It is to be noted that transmitter 60, which typically comprises a laser diode, outputs an optical signal exhibiting a specific polarity. Thus, in an exemplary embodiment, frequency selective optical coupler 30 is a polarization dependent coupler that is selected to couple optical signals having the polarization of the output optical signal of transmitter 60 to planar waveguide 20. Generally, frequency selective optical coupler 30 couples first and second downstream wavelengths to polarization independent frequency selective dual optical coupler 210, and the upstream wavelength from high index planar waveguide 50 to planar waveguide 20. The upstream optical signal propagates through first planar waveguide 20 through connector 16, and propagates through input/output optical fiber 14. It is to be noted that the architecture of bi-directional optical transceiver PLC structure 200 is distinctive in having upstream frequency selective optical coupler 30 closer to input/output optical fiber 14 than polarization independent frequency selective dual optical coupler 210, and thus the output of transmitter 60 does not propagate through polarization independent frequency selective dual optical coupler 210. Furthermore a single polarization independent dual frequency selective optical coupler 210 saves space and couples out only the desired first downstream wavelength to first detector 70 and second downstream wavelength to second detector 70. Thus device 200 of FIG. 2c is operable to supply bi-directional optical transmission at two distinct downstream wavelengths and a separate distinct upstream wavelength.

FIG. 2d illustrates a fourth embodiment of a bi-directional optical transceiver PLC structure in accordance with the principle of the invention, generally denoted 250, supporting two downstream wavelengths. PLC structure 250 comprises: substrate 12; input/output optical fiber 14; fiber attachment 16; planar waveguide 20; polarization independent frequency selective dual optical coupler 210; planar waveguide 40; first and second high index planar waveguides 120; transmitter 60, which in a preferred embodiment comprises a laser diode; and first and second detectors 70, which in a preferred embodiment each comprise a photo-detector. Input/output optical fiber 14 is connected at fiber attachment 16 to a first end of planar waveguide 20, and a second end of planar waveguide 20 is connected to a first port of polarization independent frequency selective dual optical coupler 210. One end of planar waveguide 40 is connected to a second port, the through port, of polarization independent frequency selective dual optical coupler 210, and a second end of planar waveguide 40 is connected to transmitter 60. One end of first high index planar waveguide 120 is connected to a third port of polarization independent frequency selective dual optical coupler 210, and a second end of first high index planar waveguide 120 is connected to first detector 70. One end of second high index planar waveguide 120 is connected to a fourth port of polarization independent frequency selective dual optical coupler 210, and a second end of second high index planar waveguide 120 is connected to second detector 70.

In operation, an incoming optical signal propagating through input/output optical fiber 14 is connected through fiber attachment 16 to planar waveguide 20. Fiber attachment 16 is preferably an embedded pigtail assembly. The incoming optical signal comprises downstream transmission at a first and second wavelength, with a first wavelength being typically on the order of 1.5 μm, and a second wavelength being typically on the order of 1.49 μm. The incoming optical signal, comprising first and second wavelengths, propagates through planar waveguide 20 to polarization independent frequency selective dual optical coupler 210. Polarization independent frequency selective dual optical coupler 210 is operable to couple out a first downstream wavelength to first high index planar waveguide 120, and a second downstream wavelength to second high index planar waveguide 120. The first downstream wavelength thus propagates through first high index planar waveguide 120 to first detector 70 and the second downstream wavelength thus propagates through second high index planar waveguide 120 to second detector 70.

Transmitter 60 is operable to transmit upstream signals at a third wavelength, typically on the order of 1.3 μm, the third wavelength being distinct and separated from the first and second downstream wavelengths. The upstream optical signal output from transmitter 60 propagates through planar waveguide 40 to polarization independent frequency selective dual optical coupler 210, and is passed through to planar waveguide 20. The upstream optical signal propagates through first planar waveguide 20, through connector 16 and propagates through input/output optical fiber 14. It is to be noted that the architecture of bi-directional optical transceiver PLC structure 250 is distinctive in having a single polarization independent dual frequency selective optical coupler 210 which thus saves space and is operable to couple out the desired first downstream wavelength to first detector 70 and the second downstream wavelength to second detector 70. Thus device 250 of FIG. 2d is operable to supply bi-directional optical transmission at two distinct downstream wavelengths and a separate distinct upstream wavelength.

FIG. 2e illustrates a fifth embodiment of a bi-directional optical transceiver PLC structure in accordance with the principle of the invention, generally denoted 300, supporting two downstream wavelengths. PLC structure 300 comprises: substrate 12; input/output optical fiber 14; fiber attachment 16; planar waveguide 20; polarization independent frequency selective dual optical coupler 210; planar waveguide 40; first and second high index planar waveguides 120; first and second extinction enhancement gratings 90; transmitter 60, which in a preferred embodiment comprises a laser diode; and first and second detectors 70, which in a preferred embodiment each comprise a photo-detector. Input/output optical fiber 14 is connected at fiber attachment 16 to a first end of planar waveguide 20, and a second end of planar waveguide 20 is connected to a first port of polarization independent frequency selective dual optical coupler 210. One end of planar waveguide 40 is connected to a second port, the through port, of polarization independent frequency selective dual optical coupler 210, and a second end of planar waveguide 40 is connected to transmitter 60. One end of first high index planar waveguide 120 is connected to a third port of polarization independent frequency selective dual optical coupler 210, and a second end of first high index planar waveguide 120 is connected to first detector 70. First extinction enhancement grating 90 is written on a portion of first high index planar waveguide 120 between the third port of polarization independent frequency selective dual optical coupler 210 and first detector 70. One end of second high index planar waveguide 120 is connected to a fourth port of polarization independent frequency selective dual optical coupler 210, and a second end of second high index planar waveguide 120 is connected to second detector 70. Second extinction enhancement grating 90 is written on a portion of second high index planar waveguide 120 between the fourth port of polarization independent frequency selective dual optical coupler 210 and second detector 70.

In operation bidirectional optical transceiver PLC structure 300 operates in all respects in a manner similar to that described above in relation to bi-direction optical transceiver PLC structure 250 of FIG. 2d, with an improved S/N ratio as a result of the operation of first and second extinction enhancement grating 90. First and second extinction enhancement gratings 90 are preferably respectively selected to be a notch filter suppressing all but the designated first and second downstream wavelengths to be detected respectively by first and second detectors 70.

FIG. 3a illustrates a high level schematic diagram of an embodiment of frequency selective optical coupler 30 of FIGS. 1a-1b and 2a-2c in accordance with the principle of the invention. The core area of high index planar waveguide 50 is placed in close proximity to the core area of planar waveguide 20 that continues as planar waveguide 40 defining an evanescent coupling region 350. It is to be understood that planar waveguide 40 is an extension of planar waveguide 20, and the term planar waveguide 40 is meant to include the portion of either planar waveguide 20 and/or planar waveguide 40 in evanescent coupling region 350. High index planar waveguide 50 is shown curved, however this is not meant to be limiting in any way. N_{eff} for the TM and TE modes of high index planar waveguide 50 are dissimilar, and thus high index planar waveguide 50 is formed with the appropriate refractive index and dimensioned to exhibit an N_{eff} which matches the N_{eff} of planar waveguide 20, 40 in coupling region 350 for the mode of the output signal of transmitter 60. Thus light in the mode (TM or TE) for which the N_{eff} of high index planar waveguide 50 matches that of planar waveguide 20, 40 will couple from high index planar waveguide 50 to planar waveguide 20, 40 over evanescent coupling region 350 and propagate to input/output optical fiber 14 of FIGS. 1a-1b and 2a-2c.

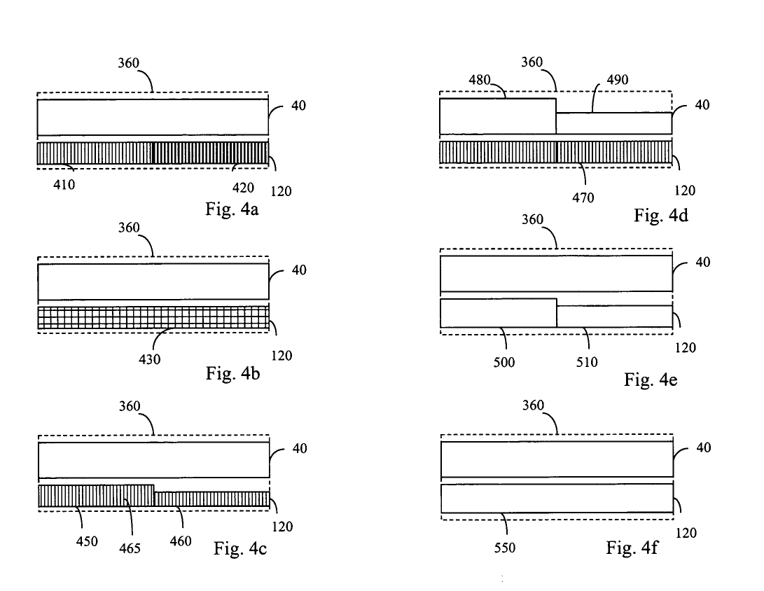

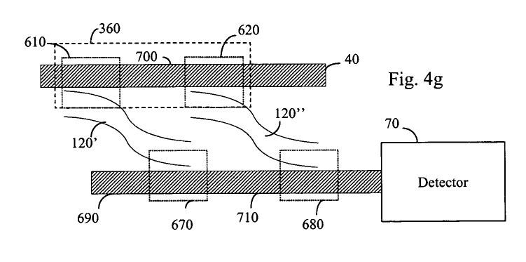

FIG. 3b illustrates a high level schematic diagram of an embodiment of polarization independent frequency selective optical coupler 110 of FIGS. 2a, 2b in accordance with the principle of the invention. The core area of high index planar waveguide 120 is placed in close proximity to the core area of planar waveguide 40 defining an evanescent coupling region 360. It is to be understood that planar waveguide 40 is an extension of planar waveguide 20, and the term planar waveguide 40 is meant to include the portion of either planar waveguide 20 and/or planar waveguide 40 in evanescent coupling region 360. High index planar waveguide 120 is shown curved, however this is not meant to be limiting in any way. The operation of coupling in evanescent coupling region 360 will be explained further hereinto below in reference to FIGS. 4a-4g. Evanescent coupling region 360 is shown as a single evanescent coupling region, however this is not meant to be limiting in any way. A plurality of evanescent coupling regions may be formed as will be explained further hereinto below, without exceeding the scope of the invention.

FIG. 3c illustrates a high level schematic diagram of an embodiment of polarization independent frequency selective dual optical coupler 210 of FIGS. 2c-2e in accordance with the principle of the invention. The core area of first high index planar waveguide 120 is placed in close proximity to the core area of planar waveguide 40 defining a first evanescent coupling region 360. It is to be understood that planar waveguide 40 is an extension of planar waveguide 20, and the term planar waveguide 40 is meant to include the portion of either planar waveguide 20 and/or planar waveguide 40 in evanescent coupling region 360. The core area of second high index planar waveguide 120 is placed in close proximity to the core area of planar waveguide 40 defining a second evanescent coupling region 360. First and second high index planar waveguide 120 are shown curved, however this is not meant to be limiting in any way. The operation of coupling in first and second evanescent coupling region 360 will be explained further hereinto below in reference to the various embodiments of FIGS. 4a-4g. Each of first and second evanescent coupling regions 360 is shown as a single evanescent coupling region, however this is not meant to be limiting in any way. A plurality of evanescent coupling regions may be formed as will be explained further hereinto below, without exceeding the scope of the invention. It is to be understood that first evanescent coupling region 360 is not required to be of the same embodiment as second evanescent coupling region 360, and may in fact be different without exceeding the scope of the invention.

FIG. 4a illustrates a high level schematic diagram of a first embodiment of an evanescent coupling region 360 of polarization independent frequency selective optical coupler 110 of FIGS. 2a, 2b and 3b and of polarization independent frequency selective dual optical coupler 210 of FIG. 2c-2e and 3c. Evanescent coupling region 360 is defined by a portion of high index planar waveguide 120 having written thereon a first grating 410 and a second grating 420, being in close proximity to a portion of planar waveguide 40. Gratings 410 and 420 differ in a manner to be further described hereinto below. High index planar waveguide 120 is preferably formed and dimensioned to be operative in a single mode region of operation for at least the desired downstream wavelength. Preferably, high index planar waveguide is formed so as to exhibit a steep N_{eff} vs. wavelength slope, thus being operable to form a discriminating filter. First grating 410 is formed to match the phase of a first one of the TM and TE modes at the desired downstream wavelength in planar waveguide 40 and high index planar waveguide 120. Matching the phase creates a coupling condition for the mode with the matched phase. Second grating 420 is formed to match the phase of a second one of the TM and TE modes at the desired downstream wavelength in planar waveguide 40 and high index planar waveguide 120. In one embodiment, both the portion of planar waveguide 40 and the portion of high index planar waveguide 120 within evanescent coupling region 360 are comprised of core material having a refractive index between 2.0 and 2.2, preferably between 2.0 and 2.1. In a further embodiment the height of both the portion of planar waveguide 40 and the portion of high index planar waveguide 120 within evanescent coupling region 360 is between 0.15 and 3.0 microns, with a width of between 0.8 and 1.3 microns.

In operation, first grating 410 is operative to couple a first one of the TM and TE modes of the desired downstream wavelength propagating in planar waveguide 40 to high index planar waveguide 120. Second grating 420 is operative to couple a second one of the TM and TE modes of the desired downstream wavelength to high index planar waveguide 120, thus enabling a polarization independent frequency selective optical coupler. Advantageously, high index planar waveguide 120 is formed and dimensioned to improve the discrimination of the frequency selective coupling, and apodization is utilized to reduce the side lobes.

FIG. 4b illustrates a high level schematic diagram of a second embodiment of an evanescent coupling region 360 of polarization independent frequency selective optical coupler 110 of FIGS. 2a, 2b and 3b and of polarization independent frequency selective dual optical coupler 210 of FIG. 2c-2e and 3c. Evanescent coupling region 360 is defined by a portion of high index planar waveguide 120 having written thereon a combined grating 430 being in close proximity to a portion of planar waveguide 40. High index planar waveguide 120 is formed and dimensioned to be operative in a single mode region of operation for both downstream signals.

Preferably, high index planar waveguide is formed so as to exhibit a steep N_{eff} vs. wavelength slope, thus being operable to form a discriminating filter. Combined grating 430 comprises first grating 410 and second grating 420 as described above in relation to FIG. 4a superimposed on each other. The TM and TE modes are orthogonal to each other, and thus a grating written for the TM mode may be superimposed over a grating written for the TE mode without interference. In one embodiment, both the portion of planar waveguide 40 and the portion of high index planar waveguide 120 within evanescent coupling region 360 are comprised of core material having a refractive index between 2.0 and 2.2, preferably between 2.0 and 2.1. In a further embodiment the height of both the portion of planar waveguide 40 and the portion of high index planar waveguide 120 within evanescent coupling region 360 is between 0.15 and 3.0 microns, with a width of between 0.8 and 1.3 microns.

The operation of combined grating 430 is in all respects similar to that described above in relation to gratings 410 and 420 of FIG. 4a, and thus the operation of polarization independent frequency selective optical coupler 110 of FIGS. 2a-2b and 3b and of polarization independent frequency selective dual optical coupler 210 of FIG. 2c-2e and 3c as implemented utilizing the evanescent coupling region 360 of FIG. 4b is thus in all respects similar to that described above in relation to the operation of polarization independent frequency selective optical coupler 110 of FIGS. 2a-2b and 3b and of polarization independent frequency selective dual optical coupler 210 of FIG. 2c-2e and 3c as implemented utilizing the evanescent coupling region 360 of FIG. 4a.

FIG. 4c illustrates a high level schematic diagram of a third embodiment of an evanescent coupling region 360 of polarization independent frequency selective optical coupler 110 of FIGS. 2a, 2b and 3b and of polarization independent frequency selective dual optical coupler 210 of FIG. 2c-2e and 3c. Evanescent coupling region 360 is defined by a portion of planar waveguide 40 being in close proximity to a portion of high index planar waveguide 120, the portion of high index planar waveguide 120 exhibiting varying heights and/or widths defining a first region 450 and a second region 460. An optional uniform grating 465 is written on both first region 450 and second region 460. High index planar waveguide 120 is preferably formed and dimensioned to be operative in a single mode region of operation for at least the desired downstream wavelength over both first and second regions 450, 460. The slope of the relationship between N_{eff} and wavelength differs for each of first and second regions 450, 460 and is selected in combination with the period of optional uniform grating 465. N_{eff} of region 450 in combination with optional uniform grating 465 matches the phase in planar waveguide 40 for a first one of the TM and TE modes at the desired downstream wavelength. N_{eff} of region 460 in combination with optional uniform grating 465 matches the phase of planar waveguide 40 for a second one of the TM and TE modes at the desired downstream wavelength.

In one embodiment, both the portion of planar waveguide 40 and the portion of high index planar waveguide 120 within evanescent coupling region 360 are comprised of core material having a refractive index between 2.0 and 2.2, preferably between 2.0 and 2.1. In a further embodiment the height of both the portion of planar waveguide 40 and the portion of high index planar waveguide 120 within evanescent coupling region 360 is between 0.15 and 3.0 microns, with a width of between 0.8 and 1.3 microns.

In operation, first region 450 is operative to couple a first one of the TM and TE modes of the desired downstream wavelength to high index planar waveguide 120. Second region 460 is operative to couple a second one of the TM and TE modes of the desired downstream wavelength to high index planar waveguide 120, thus enabling a polarization independent frequency selective optical coupler. Advantageously, high index planar waveguide 120 is formed and dimensioned to improve the discrimination of the frequency selective coupling, and apodization is utilized to reduce the side lobes.

FIG. 4d illustrates a high level schematic diagram of a fourth embodiment of an evanescent coupling region 360 of polarization independent frequency selective optical coupler 110 of FIGS. 2a, 2b and 3b and of polarization independent frequency selective dual optical coupler 210 of FIG. 2c-2e and 3c. Evanescent coupling region 360 is defined by a portion of planar waveguide 40 being in close proximity to a portion of high index planar waveguide 120, the portion of planar waveguide 40 exhibiting varying heights and/or widths defining a first region 480 and a second region 490. An optional uniform grating 470 is optionally written on the portion of high index planar waveguide 120 defining evanescent coupling region 360. High index planar waveguide 120 is preferably formed and dimensioned to be operative in a single mode region of operation for at least the desired downstream wavelength. The slope of the relationship between N_{eff} and wavelength differs for each of first and second regions 480, 490 and is selected in combination with the period of optional uniform grating 470 of high index planar waveguide 120. N_{eff} of region 480 in combination with optional uniform grating 470 and the N_{eff} of high index planar waveguide 120 matches the phase for a first one of the TM and TE modes at the desired downstream wavelength. N_{eff} of region 490 in combination with optional uniform grating 470 and the N_{eff} of high index planar waveguide 120 matches the phase for a second one of the TM and TE modes at the desired downstream wavelength.

In one embodiment, both the portion of planar waveguide 40 and the portion of high index planar waveguide 120 within evanescent coupling region 360 are comprised of core material having a refractive index between 2.0 and 2.2, preferably between 2.0 and 2.1. In a further embodiment the height of both the portion of planar waveguide 40 and the portion of high index planar waveguide 120 within evanescent coupling region 360 is between 0.15 and 3.0 microns, with a width of between 0.8 and 1.3 microns.

In operation, first region 480 is operative to couple a first one of the TM and TE modes of the desired downstream wavelength to high index planar waveguide 120. Second region 490 is operative to couple a second one of the TM and TE modes of the desired downstream wavelength to high index planar waveguide 120, thus enabling a polarization independent frequency selective optical coupler. Advantageously, high index planar waveguide 120 is formed and dimensioned to improve the discrimination of the frequency selective coupling, and apodization is utilized to reduce the side lobes.

FIG. 4e illustrates a high level schematic diagram of a fifth embodiment of an evanescent coupling region 360 of polarization independent frequency selective optical coupler 110 of FIGS. 2a, 2b and 3b and of polarization independent frequency selective dual optical coupler 210 of FIG. 2c-2e and 3c. Evanescent coupling region 360 is defined by a portion of planar waveguide 40 being in close proximity to a portion of high index planar waveguide 120, the portion of high index planar waveguide 120 exhibiting varying heights and/or widths defining a first region 500 and a second region 510. At least a portion of high index planar waveguide 120 is formed and dimensioned to be operative in a multi-mode region of operation for at least the desired downstream wavelength. By multi-mode region of operation is meant the region of operation in which high order modes are present, typically for each high order mode both the TM and TE modes exist. Planar waveguide 40 is formed and dimensioned to be operative in the single mode region of operation. The relationship between N_{eff} and wavelength differs for each mode in the multi-mode operation, and exhibits a different set of relationships in each of first and second regions 500, 510. The width and/or height of first region 500 is selected so that N_{eff} for the TM mode of the fundamental mode supported in planar waveguide 40 matches N_{eff} of the TM mode for one of the supported modes in first region 500. The width and/or height of second region 510 is selected so that N_{eff} for the TE mode of the fundamental mode supported in planar waveguide 40 matches N_{eff} of the TE mode for another of the supported modes in first region 500.

In one embodiment, both the portion of planar waveguide 40 and the portion of high index planar waveguide 120 within evanescent coupling region 360 are comprised of core material having a refractive index between 2.0 and 2.2, preferably between 2.0 and 2.1. In a further embodiment the height of both the portion of planar waveguide 40 and the portion of high index planar waveguide 120 within evanescent coupling region 360 is between 0.15 and 3.0 microns. In such an embodiment the width of planar waveguide 40 is preferably between 0.8 and 1.3 microns and the width of high index planar waveguide 120 is between 2 and 7 microns.

In operation, first region 500 is operative to couple the TM mode of the desired downstream wavelength to high index planar waveguide 120, where it propagates in the TM mode of either the fundamental or a supported high order mode. Second region 510 is operative to couple the TE mode of the desired downstream wavelength to high index planar waveguide 120, where it propagates in the TE mode of either the fundamental or a supported high order mode, thus enabling a polarization independent frequency selective optical coupler. The TE and TM modes are each coupled in different modes supported by high index planar waveguide 120. Advantageously, high index planar waveguide 120 is formed and dimensioned to improve the discrimination of the frequency selective coupling, and apodization is utilized to reduce the side lobes.

While the above has been described in an embodiment in which high index planar waveguide 120 supports multi-mode operation, it is to be understood that the requirement for multi-mode operation need not be satisfied over the entire length of high index planar waveguide 120. In particular, one of first region 500 and second region 510 may be dimensioned to support single mode operation without exceeding the scope of the invention. In such an embodiment, a first one of the TM and TE modes is coupled into the fundamental mode supported in the single mode region of high index planar waveguide 120, and a second one of the TM and TE modes is coupled into a supported high order mode of high index planar waveguide 120 in the region for which multi-mode operation is supported.

FIG. 4f illustrates a high level schematic diagram of a sixth embodiment of an evanescent coupling region 360 of polarization independent frequency selective optical coupler 110 of FIGS. 2a, 2b and 3b and of polarization independent frequency selective dual optical coupler 210 of FIG. 2c-2e and 3c. Evanescent coupling region 360 is defined by a portion of planar waveguide 40 being in close proximity to a portion of high index planar waveguide 120. High index planar waveguide 120 is formed and dimensioned to be operative in a multi-mode region of operation for at least the desired downstream wavelength. By multi-mode region of operation is meant the region of operation in which high order modes are present, typically for each high order mode both the TM and TE modes exist. Planar waveguide 40 is formed and dimensioned to be operative in the single mode region of operation. The relationship between N_{eff} and wavelength differs for each and every mode in the multi-mode operation. The width and/or height and the refractive index of high index planar waveguide 120 in combination with the width and/or height and the refractive index of planar waveguide 40 is selected so that N_{eff} for the TM mode of the fundamental mode supported in planar waveguide 40 matches N_{eff} of the TM mode for one of the supported modes in high index planar waveguide 120 and that N_{eff} for the TE mode of the fundamental mode supported in planar waveguide 40 matches N_{eff} of the TE mode for another of the supported modes in high index planar waveguide 120.

In one embodiment, both the portion of planar waveguide 40 and the portion of high index planar waveguide 120 within evanescent coupling region 360 are comprised of core material having a refractive index between 2.0 and 2.2, preferably between 2.0 and 2.1. In a further embodiment the height of both the portion of planar waveguide 40 and the portion of high index planar waveguide 120 within evanescent coupling region 360 is between 0.15 and 3.0 microns. In such an embodiment the width of planar waveguide 40 is preferably between 0.8 and 1.3 microns and the width of high index planar waveguide 120 is between 2 and 7 microns.

In operation, coupling region 360 is operative to couple the TM mode of the desired downstream wavelength to high index planar waveguide 120, where it propagates in the TM mode of either the fundamental or a supported high order mode. Coupling region 360 is further operative to couple the TE mode of the desired downstream wavelength to high index planar waveguide 120, where it propagates in the TE mode of either the fundamental or a supported high order mode, the propagation mode of the TM and TE modes being different. In particular, if for example the TM mode is propagating in the fundamental mode, the TE mode is propagating in a high order mode. This enables a polarization independent frequency selective optical coupler. Advantageously, high index planar waveguide 120 is formed and dimensioned to improve the discrimination of the frequency selective coupling, and apodization is utilized to reduce the side lobes.

FIG. 4g illustrates a high level schematic diagram of a seventh embodiment of an evanescent coupling region 360 of polarization independent frequency selective optical coupler 110 of FIGS. 2a, 2b and 3b and of polarization independent frequency selective dual optical coupler 210 of FIG. 2c-2e and 3c. The embodiment of FIG. 4g comprises planar waveguides 40 and 690; high index planar waveguides 120′ and 120″; evanescent coupling region 360 comprising sub-regions 610 and 620 separated by region 700 of planar waveguide 40; evanescent coupling regions 670 and 680 separated by region 710 of planar waveguide 690; and detector 70. Evanescent coupling region 360 of polarization independent frequency selective optical coupler 110 of FIGS. 2a, 2b and 3b and of polarization independent frequency selective dual optical coupler 210 of FIG. 2c-2e and 3c comprises one or more sub-regions 610 and 620. High index planar waveguide 120 comprises two high index planar waveguides 120′ and 120″. In an exemplary embodiment, planar waveguide 690 comprises the input planar waveguide to detector 70. In an alternative embodiment, planar waveguide 690 comprises a planar waveguide connected to the input of detector 70. Preferably, planar waveguide 690 is formed and dimensioned to be operative in single mode operation.

Evanescent coupling sub-region 610 is defined by a portion of planar waveguide 40 being in close proximity to a portion of high index planar waveguide 120′. Evanescent coupling sub-region 620 is defined by a portion of planar waveguide 40 being in close proximity to a portion of high index planar waveguide 120″. Evanescent sub-region 610 and 620 are shown herein as being sub-regions of a single evanescent coupling region 360 separated by region 700 however this is not meant to be limiting in any way. Evanescent sub-regions 610 and 620 may be formed at a distance from each other thus forming separate and distinct evanescent coupling regions without exceeding the scope of the invention.

The width and/or height and the refractive index of high index planar waveguide 120′ in combination with the width and/or height and the refractive index of planar waveguide 40 is selected so that N_{eff} for the TM mode of the fundamental mode supported in planar waveguide 40 matches N_{eff} of the TM mode in high index planar waveguide 120′. Furthermore, the width and/or height and the refractive index of high index planar waveguide 120′ in combination with the width and/or height and the refractive index of planar waveguide 690 is selected so that N_{eff} for the TM mode supported in planar waveguide 690 matches N_{eff} of the TM mode in high index planar waveguide 120′. The width and/or height and the refractive index of high index planar waveguide 120″ in combination with the width and/or height and the refractive index of planar waveguide 40 is selected so that N_{eff} for the TE mode of the fundamental mode supported in planar waveguide 40 matches N_{eff} of the TE mode in high index planar waveguide 120″. Furthermore, the width and/or height and the refractive index of high index planar waveguide 120″ in combination with the width and/or height and the refractive index of planar waveguide 690 is selected so that N_{eff} for the TE mode supported in planar waveguide 690 matches N_{eff} of the TE mode in high index planar waveguide 120′. Preferably, high index planar waveguide 120′ and high index planar waveguide 120″ are each formed and dimensioned to be operative in single mode operation for at least the desired downstream wavelength.

Evanescent coupling region 670 is defined by a portion of planar waveguide 690 being in close proximity to a portion of high index planar waveguide 120′. Evanescent coupling region 680 is defined by a portion of planar waveguide 690 being in close proximity to a portion of high index planar waveguide 120″. Evanescent coupling regions 670 and 680 are herein described as being separate evanescent coupling regions separated by region 710 of planar waveguide 690, however this is not meant to be limiting in any way. Evanescent coupling regions 670 and 680 may be formed as sub-portions of a larger single evanescent coupling region without exceeding the scope of the invention.

In one embodiment, planar waveguides 40 and 690 and high index planar waveguides 120′ and 120″ are comprised of core material having a refractive index between 2.0 and 2.2, preferably between 2.0 and 2.1. In a further embodiment the height of the portions of planar waveguides 40 and 690 within evanescent coupling regions 610, 620, 670 and 680 is between 0.15 and 3.0 microns and the width is between 0.8 and 1.3 microns. In one further embodiment the height of high index planar waveguides 120′, 120″ is between 0.15 and 3.0 microns and the width is between 2 and 7 microns.

In operation, evanescent coupling region 610 is operative to couple the TM mode of the desired downstream wavelength to high index planar waveguide 120′, and evanescent coupling region 670 is operative to couple the TM mode of the desired downstream wavelength to planar waveguide 690. The TM mode is thus double filtered, having been filtered by both frequency selective evanescent coupling regions 610 and 670. Evanescent coupling region 620 is operative to couple the TE mode of the desired downstream wavelength to high index planar waveguide 120″ and evanescent coupling region 680 is operative to couple the TE mode of the desired downstream wavelength to planar waveguide 690. The TE mode is thus double filtered, having been filtered by both frequency selective evanescent coupling regions 620 and 680. Both the TM and TE modes of the optical signal have thus been double filtered and propagate in single mode waveguide 690 to detector 70.

The length of high index planar waveguides 120′ and 120″ are selected so as to ensure equal propagation times for both the TM and TE modes from the input of planar waveguide 40 to detector 70. This minimizes any polarization mode dispersion. In particular, the propagation time of the TM mode through high index planar waveguide 120′ and region 710 of planar waveguide 690 may be longer or shorter than the propagation time of the TE mode through the portion 700 of planar waveguide 40 and high index planar waveguide 120″. The length of either high index planar waveguide 120′ or 120″ is thus adjusted to compensate for any difference in overall propagation time between the paths of the TE and TM modes. This enables a polarization independent frequency selective optical coupler having minimal polarization mode dispersion. Advantageously, high index planar waveguides 120′ and 120″ are formed and dimensioned to improve the discrimination of the frequency selective coupling, and apodization is utilized to reduce the side lobes.

The above has been described with the TM mode propagating through high index planar waveguide 120′ and the TE mode propagating through high index planar waveguide 120″ however this is not meant to be limiting in any way. In particular, in another embodiment the TE mode propagates through high index planar waveguide 120′ and the TM mode propagates through high index planar waveguide 120″ without exceeding the scope of the invention.

It is to be appreciated that either high index planar waveguide 120′ or high index planar waveguide 120″ may be produced with a grating within one or more of evanescent coupling regions 610, 620, 670 and 680 without exceeding the scope of the invention. Furthermore, extinction grating 90 of FIG. 2e may be written on planar waveguide 690, and/or on high index planar waveguides 120′ and 120″ without exceeding the scope of the invention. It is to be noted that the configuration of FIG. 4g thus advantageously supplies a filtered polarization independent output on single mode waveguide 690.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof which would occur to persons skilled in the art upon reading the foregoing description.

1. A polarization independent, frequency selective coupler for coupling an optical signal having at least one wavelength and an arbitrary polarization state, said polarization independent, frequency selective optical coupler comprising:
a first waveguide; and
at least one second waveguide, a first portion of said at least one second waveguide being in close proximity to said first waveguide thus forming at least one evanescent coupling region,
said at least one evanescent coupling region exhibiting a first phase match condition coupling the TM mode of an optical signal propagating in said first waveguide to said at least one second waveguide and a second phase match condition coupling the TE mode of said optical signal propagating in said first waveguide to said at least one second waveguide, said first phase match condition being different than said second phase match condition.

2. A polarization independent frequency selective coupler according to claim 1, further comprising a first grating written on a first portion of said at least one second waveguide within said at least one evanescent coupling region, said first grating being associated with said first phase match condition, and a second grating written on a second portion of said at least one second waveguide within said at least one evanescent coupling region, said second grating being associated with said second phase match condition.

3. A polarization independent frequency selective coupler according to claim 2, wherein said first grating exhibits a first period and said second grating exhibits a second period, said first period being different than said second period.

4. A polarization independent frequency selective coupler according to claim 3, wherein said first and second gratings at least partially overlap.

5. A polarization independent frequency selective coupler according to claim 3, wherein said first portion is substantially identical with said second portion, said first grating being superimposed over said second grating.

6. A polarization independent frequency selective coupler according to claim 1, wherein said at least one second waveguide forming said at least one evanescent coupling region comprises a first sub-portion having a first characteristic height and width being associated with said first phase match condition and a second sub-portion having a second characteristic height and width being associated with said second phase match condition.

7. A polarization independent frequency selective coupler according to claim 6, further comprising a grating written on at least a portion of one of said first sub-portion and said second sub-portion.

8. A polarization independent frequency selective coupler according to claim 7, wherein said grating exhibits a uniform period over said at least a portion of one of said first sub-portion and said second sub-portion.

9. A polarization independent frequency selective coupler according to claim 8, wherein said first waveguide comprises core material exhibiting a refractive index between 1.48 and 1.55 at 1.5 μm and said at least one second waveguide comprises core material exhibiting a refractive index in excess of 1.6 at 1.5 μm.

10. A polarization independent frequency selective coupler according to claim 6, wherein said first waveguide comprises core material exhibiting a refractive index between 1.48 and 1.55 at 1.5 μm and said at least one second waveguide comprises core material exhibiting a refractive index in excess of 1.6 at 1.5 μm.

11. A polarization independent frequency selective coupler according to claim 6, wherein said first waveguide comprises core material exhibiting a refractive index in excess of 1.6 at 1.5 μm and said at least one second waveguide comprises core material exhibiting a refractive index between 1.48 and 1.55 at 1.5 μm.

12. A polarization independent frequency selective coupler according to claim 1, wherein said optical signal comprises at least one wavelength, and wherein said at least one second waveguide supports at least one high order mode at said at least one wavelength.

13. A polarization independent frequency selective coupler according to claim 12, wherein at least one of said first phase match condition coupling said TM mode and said second phase match condition coupling said TE mode is associated with said at least one high order mode.

14. A polarization independent frequency selective coupler according to claim 12, wherein said at least one second waveguide forming said at least one evanescent coupling region comprises a first sub-portion having a first characteristic height and width being associated with said first phase match condition and a second sub-portion having a second characteristic height and width being associated with said second phase match condition.

15. A polarization independent frequency selective coupler according to claim 14, wherein at least one of said first phase match condition coupling said TM mode and said second phase match condition coupling said TE mode is associated with said first sub-portion and is further associated with said at least one high order mode.

16. A polarization independent frequency selective coupler according to claim 1, wherein:
said optical signal comprises at least one wavelength;
said at least one second waveguide forming said at least one evanescent coupling region supports, at said at least one wavelength, at least two modes, at least one of said at least two modes being a high order mode;
said at least one second waveguide comprising:
a) a first sub-portion having a first characteristic height and width being associated with said first phase match condition coupling said TM mode and being further associated with a first one of said at least two modes; and
b) a second sub-portion having a second characteristic height and width being associated with said second phase match condition coupling said TE mode and being further associated with a second one of said at least two modes;
said second one of said at least two modes being different than said first one of said at least two modes.

17. A polarization independent frequency selective coupler according to claim 1, wherein said first waveguide comprises core material exhibiting a refractive index between 1.48 and 1.55 at 1.5 μm.

18. A polarization independent frequency selective coupler according to claim 1, wherein said at least one second waveguide comprises core material exhibiting a refractive index in excess of 1.6 at 1.5 μm.

19. A polarization independent frequency selective coupler according to claim 1, wherein said at least one second waveguide comprises core material exhibiting a refractive index between 2.0 and 2.2 at 1.5 μm.

20. A polarization independent frequency selective coupler according to claim 1, wherein said first waveguide comprises core material exhibiting a refractive index between 1.48 and 1.55 at 1.5 μm and said at least one second waveguide comprises core material exhibiting a refractive index between 2.0 and 2.2 at 1.5 μm.

21. A polarization independent frequency selective coupler according to claim 1, wherein said first waveguide comprises core material exhibiting a refractive index between 2.0 and 2.2 at 1.5 μm and said at least one second waveguide comprises core material exhibiting a refractive index between 2.0 and 2.2 at 1.5 μm.

22. A polarization independent frequency selective coupler according to claim 21, wherein the height of said first waveguide is between 0.15 and 0.3 microns and the width of said first waveguide is between 0.8 and 1.3 microns.

23. A polarization independent frequency selective coupler according to claim 22, wherein the height of said at least one second waveguide is between 0.15 and 0.3 microns and the width of said at least one second waveguide is between 2 and 7 microns.

24. A polarization independent frequency selective coupler according to claim 1, wherein said at least one second waveguide comprises two waveguides.

25. A polarization independent frequency selective coupler according to claim 24, wherein a first one of said two waveguides is associated with said TM mode.

26. A polarization independent frequency selective coupler according to claim 25, wherein a second one of said two waveguides is associated with said TE mode.

27. A polarization independent frequency selective coupler according to claim 24, wherein a first one of said two waveguides is associated with said TM mode, and a second one of said two waveguides is associated with said TE mode.

28. A polarization independent frequency selective coupler according to claim 27, further comprising an output waveguide, said output waveguide being in close proximity to a second portion of said first one of said two waveguides forming an evanescent coupling region, said output waveguide further being in close proximity to a second portion of said second one of said two waveguides forming an evanescent coupling region.

29. A polarization independent frequency selective optical coupler according to claim 28, wherein the length of said first one of said second two waveguides and said second one of said second two waveguides is selected so that the propagation time of said TM mode and said TE mode of said optical signal from the input of said first waveguide to the output of said output waveguide are substantially equivalent.

30. A method of polarization independent frequency selective coupling for an optical signal having at least one wavelength and an arbitrary polarization state, said polarization independent frequency selective optical coupling comprising:
coupling by a first phase match condition the TM mode of the optical signal in at least one evanescent coupling region; and
coupling by a second phase match condition the TE mode of said optical signal in said at least one evanescent coupling region,
said first phase match condition being different from said second phase match condition.

31. A polarization independent, frequency selective coupler for coupling an optical signal having at least one wavelength and an arbitrary polarization state, said polarization independent, frequency selective optical coupler comprising:
a first waveguide; and
a second waveguide, a first portion of said second waveguide being in close proximity to said first waveguide thus forming an evanescent coupling region,
said evanescent coupling region exhibiting a first phase match condition coupling the TM mode of an optical signal propagating in said first waveguide to said second waveguide and a second phase match condition coupling the TE mode of said optical signal propagating in said first waveguide to said second waveguide, said first phase match condition being different than said second phase match condition.

32. A polarization independent, frequency selective coupler according to claim 31, wherein at least one of said first and second phase match conditions are a function of one of a grating, a high order mode and a characteristic height and width.

33. A polarization independent, frequency selective coupler for coupling an optical signal having at least one wavelength and an arbitrary polarization state, said polarization independent, frequency selective optical coupler comprising:
a first waveguide acting as an input waveguide;
a second waveguide;
a third waveguide; and
a fourth waveguide acting as an output waveguide;
a first portion of said second waveguide being in close proximity to said first waveguide thus forming an evanescent coupling region exhibiting a first phase match condition coupling the TM mode of an optical signal propagating in said first waveguide to said second waveguide, a second portion of said second waveguide being in close proximity to said fourth waveguide thus forming an evanescent coupling region;
a first portion of said third waveguide being in close proximity to said first waveguide thus forming an evanescent coupling region exhibiting a second phase match condition coupling the TE mode of said optical signal propagating in said first waveguide to said third waveguide, a second portion of said second waveguide being in close proximity to said fourth waveguide thus forming an evanescent coupling region,
said first phase match condition being different than said second phase match condition.

34. A polarization independent frequency selective optical coupler according to claim 33, wherein the lengths of said second waveguide and said third waveguides are selected so that the propagation time of said TM mode and said TE mode of said optical signal from the input of said first waveguide to the output of said fourth waveguide are substantially equivalent.
